(19) United States
(12) Patent Application Publication
(10) Pub. No.: US 2009/0010598 A1
(43) Pub. Date: Jan. 8, 2009

(54) IN-SITU ELECTRICAL CONNECTOR WITH COMPOSITE STRUCTURE

(76) Inventor: Christopher J. Feeney, Wallingford, CT (US)

Correspondence Address: ARENT FOX LLP, 1050 CONNECTICUT AVENUE, N.W., SUITE 400, WASHINGTON, DC, 20036, US

(21) Appl. No.: 12/163,188

(22) Filed: Jun. 27, 2008

Related U.S. Application Data
(60) Provisional application No. 60/929,428, filed on Jun. 27, 2007.

(51) Int. Cl. G02B 6/26; H01R 4/00; H01R 43/00

(52) U.S. Cl. 385/51; 174/84 R; 29/869

(57) ABSTRACT

A connector includes a connector portion and one or more pads embedded in the connector portion and coupled to circuit paths, wherein the pads adjoin the surface of the connector portion and are exposed, and the connector portion is joined to a part by a joining mechanism. The circuit paths may comprise either, copper, brass, gold, aluminum, fiber optic material or any other material that is electrically or optically conductive. The connector portion is adjoined to the part via an joining mechanism such as, for example, nailing, soldering, pinning, welding, clamping, mating or gluing. One or more embedded pads may be embedded in a composite connector so that the embedded pads are present on one or more surfaces of the composite connector, and are connected to circuit paths inside the composite connector, allowing the composite connector to be connected to, for example, a power source.

This application claims priority from U.S. Provisional Patent Application No. 60/929,428, filed on Jun. 27, 2007, and titled “In-Situ Electrical Connector with Composite Structure,” which is incorporated by reference herein in its entirety.

### BACKGROUND OF THE INVENTION

1. Field of the Invention

The present invention relates to a connector device and method of use thereof, and in particular to a connector device that allows connection to one or a plurality of connection points within a composite or other material or part without the use of intermediate wiring.

2. Background of the Related Art

There is a general need in the art of connectors for parts, such as the art of electrical connectors for aircraft components, for such connectors to be robust, to have minimal profile and minimal weight, and to allow simple replacement of the part being connected, and of the connector itself.

Related art connectors are typically complex structures, and the connections have a tendency to break when subjected to severe atmospheric conditions such as, for example, bad weather. Such related art connectors generally contain numerous pins, such as in a radial pattern, to which individual wires must be individually connected. As a result, these parts are often difficult to manufacture and to incorporate into complex parts, such as parts comprised of composite materials that have multiple connection points or layers.

There remains a need for parts providing increased reliability, robustness and replaceability over related art connectors.

### SUMMARY OF THE INVENTION

Multi-functional structures often require electrical or optical connections. Examples of such connections include, but are not limited to, electro-thermal heating, electrical circuits, electrical bussing, embedded electrical sensors, structural health monitoring, and the like. Such connectors may be used to ensure electrical conductivity within, for example, an aircraft wing, or electro-thermal conducting in de-icing applications. There is thus a general need in the art for such connectors to be robust, have minimal profile (e.g., cross-sectional size), minimal weight, and to allow simple replacement of the part being connected and the connector itself.

For example, in the case of an aircraft, when there are freezing conditions and precipitation, it is critical that an aircraft be de-iced. Failure to do so may result among other things, in the surface of the aircraft's wings or other part of the aircraft to become too rough to provide for the smooth flow of air, thereby greatly degrading the ability of the wing to generate lift, possibly resulting in a crash. If large pieces of ice separate once the aircraft is in motion, they can be ingested into turbine engines, or may impact moving propellers and cause catastrophic failure. Thick ice can also lock up the control surfaces and prevent them from moving properly. Because of this potentially severe consequence, regular de-icing is performed at airports where temperatures are likely to dip below the freezing point. One of the more reliable de-icing techniques is the use of electro-thermal conductors or resistance elements within, for example, an aircraft wing or engine, where resistance elements may be provided with an electrical power source, and electricity from the power source and fed into the resistance elements is transformed into heat that melts ice formed on the aircraft wing or other part.

In particular, for example, in the de-icing and anti-icing of aircraft wings, the electrical energizing of resistance elements formed in the aircraft parts may be used. Electrical energy for example may be used to cause the resistance elements to become heated and to raise the temperature of the part so as to melt any ice which may have formed thereon.

Electrical energy can also be used to maintain the leading edge at a temperature range to prevent ice from forming in an anti-icer mode.

In this third technique, as in any similar electrical technique, electrical power is needed to achieve the de-icing or anti-icing function.

Conventional connectors are typically relatively heavy, compared to the wires or other components to which they are connected. Such conventional connectors generally contain wires or other means of electrical conductivity, and these wires and electrical conduction features generally represent as many potential electrical failure paths. Furthermore, replacing and/or disconnecting and reconnecting wires and connectors may present difficulties and added costs.

Aspects of the present invention meet the above-identified needs, as well as others, by providing various connectors that allow the establishment of reliable electrical conduction between composite portions forming a greater assembly, such as aircraft parts making up an aircraft. Aspects of the present invention provide an electrical or optical connector for a part such as a composite part, and the connector may be located in close proximity to the part in a manner that ensures adequate electrical or optical conductivity between the connector and the part.

In a first exemplary variation of the present invention, a connector system includes a connector portion and one or more pads embedded in the connector portion and coupled to circuit paths, wherein the pads adjoin the surface of the connector portion and are exposed, and the circuit paths may be either copper, brass, gold, aluminum, fiber optic material or any other material that is electrically or optically conductive. The connector portion is adjoined to the part via an attaching mechanism such as at least, for example, nailing, soldering, pinning, welding, clamping, mating or gluing. According to various exemplary variations, the pads and/or the conductors are electrically or optically conductive or both. Accordingly, an electrical or optical circuit may be established between the connector portion and the part, and no wiring or other connection between the connector portion and the part is needed.

According to another exemplary variation of the present invention, one or more embedded pads may be embedded in a composite connector so that the embedded pads are present on one or more surfaces of the composite connector, and the embedded pads are connected to conductors inside the composite connector. As a result, the composite connector can be connected to, for example, a power source. Furthermore, the connector may be a female connector, and the female composite connector may engage in a mating relationship with a male composite connector that also includes embedded pads present on one or more surface of the male composite connector. According to this other exemplary variation, the pads of the female composite connector and the pads of the male composite connector are located on the respective surfaces of the female composite connector and of the male composite connector in such a way as to be in contact with each other and form an electrical or optical connection when the male connector and the female connector are engaged in a mating relationship. According to this exemplary variation, the male and the female composite connectors may be attached to each other by, for example, nailing, soldering, pinning, welding, clamping, mating or gluing to keep both connectors close enough to each other to ensure adequate electrical or optical conductivity between the connectors.

Furthermore, connectors may be brought and kept in contact together to ensure electrical and/or optical conductivity via the application of a mechanical pressure, or by soldering, welding, plating, and the like. The connectors may also be kept in contact to ensure electrical conductivity via mechanical features such as by using a mating connector probe or a clip-on.

Among other advantages, the various exemplary aspects of connectors in accordance with aspects of the present invention eliminate the need for direct wiring or other coupling between the composite connectors, and allows the connectors to be more robust and more easily removable and replaceable. These exemplary aspects of connectors can also lighten the wiring system or harnessing system for the final product (e.g., an aircraft) in which the part is incorporated over conventional connectors.

Among other uses, the connectors and connector portions in accordance with aspects of the present invention are usable with aircraft composite part manufacturing and use, such as is disclosed in applicant's co-pending to U.S. Provisional Patent Application No. 60/690,151 titled “HYDRAULIC PRESSURIZING CONTAINMENT VESSEL METHOD OF USE THEREOF” filed Jun. 14, 2005, and corresponding to U.S. patent application Ser. No. 11/451,300 tiled “HYDRAULIC PRESSURIZING CONTAINMENT VESSEL METHOD OF USE THEREOF” filed Jun. 13, 2006; U.S. Provisional Patent Application No. 60/814,075 titled “DEVICE FOR PREFORMING CONSOLIDATION AND METHOD OF USE THEREOF” filed Jun. 16, 2006; and U.S. Provisional Patent Application No. 60/801,046 titled “SMART COMPOSITES AND METHOD OF USE THEREOF” filed May 18, 2006, each of which is incorporated by reference in its entirety herein.

Additional advantages and novel features will be set forth in part in the description that follows, and in part will become more apparent to those skilled in the art upon examination of the following or upon learning by practice of aspects the present invention.

### BRIEF DESCRIPTION OF THE DRAWINGS

Various exemplary aspects of the systems and methods will be described in detail, with reference to the following figures, wherein:

FIGS. 1A-1B are side and top views of a physical connector according to an exemplary variation of the present invention; and

FIGS. 2A-2C are perspective and side views of a other exemplary aspects of connectors in a functional relationship.

### DETAILED DESCRIPTION

These and other features and advantages are described in, or are apparent from, the following detailed description of various exemplary variations of the systems and methods in accordance with aspects of the present invention. It should also be noted that although the conductors referred to in the description below are referred in an exemplary manner as electrical connectors, they may similarly provide optical or other connecting functions.

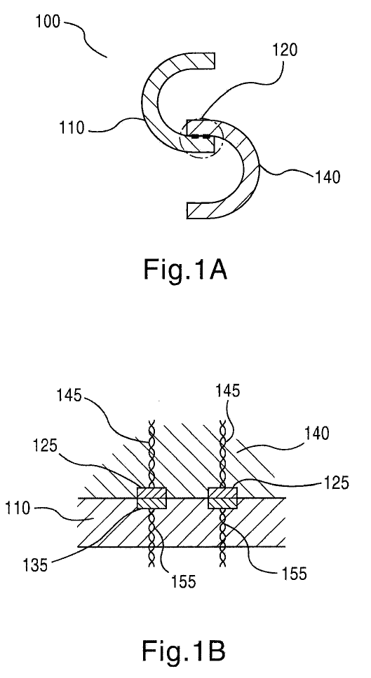

FIGS. 1A-1B illustrate exemplary views of mechanically connectable parts such as, for example, connector portions 110 and 140, in a connector system 100, according to a first exemplary variation of the present invention. As shown in FIG. 1A, the first mechanically connectable part 110 is attached to, or otherwise maintained in close contact with, a second mechanically connectable part 140. For example, both portions 110 and 140 may be mechanically connectable parts used as part of a connector system 100. Accordingly, any structures that may be connected to the mechanically connectable parts 110 and 140, respectively, may thus be locked together. Examples of such structures are engine housing and a cover that locks over the engine housing, wherein the engine housing and the cover have mechanically connectable parts that engage each other in a complementary relationship so as to ensure an adequate connection between the engine housing and the cover.

According to various exemplary aspects of this invention, one or both mechanically connectable parts 110 or 140 may also include composite portions, in which circuit paths and conductive pads 125 or 135 are embedded to conduct an electrical or optical signal throughout the composite mechanically connectable parts 110 or 140. Accordingly, an electrical or optical signal may be transmitted throughout the mechanically connectable parts 110 or 140 through the conductive embedded pads 125 or 135 and the circuit paths 145 or 155.

FIG. 1B is an enlarged view of the area 120. As shown in FIG. 1B, according to various exemplary aspects of this invention, the first mechanically connectable part 110 may include embedded pads 125 that are capable of conducting an electrical or optical signal and that are exposed at the surface of the mechanically connectable part 110. The second mechanically connectable part 140 may also include embedded pads 135 that are capable of conducting an electrical or optical signal and that are exposed at the surface of the mechanically connectable part 140. According to various exemplary aspects, when the first mechanically connectable part 110 is installed adjacent to the second mechanically connectable part 140 as illustrated in FIGS. 1A-1B, the embedded pads 125 and 135, of the first and second mechanically connectable parts 110 and 140 respectively, are in contact with each other. Thus, because the embedded pads 125 and 135 may be electrical or optical conductors, electrical or optical conduction may be achieved between the first and second mechanically connectable parts 110 and 140.

According to various aspects of this invention, the embedded pads 125 or 135 may be connected via circuit paths 145 or 155 extending through the mechanically connectable parts 110 and 140, respectively. The conductors 145 and 155 may be connected to, for example, a remote power source, so that an electrical circuit or other circuit path may be formed when the pads 125 and 135 are in contact with each other upon locking of the mechanically connectable parts 110 and 140.

It should be noted that although the mechanically connectable parts 110 and 140 are illustrated as being joined in a locking relationship, the two mechanically connectable parts 110 and 140 may be maintained in contact with each other via any joining or attaching mechanism such as soldering, welding, nailing, riveting, clamping, mating, gluing, or other retaining method that retains the first mechanically connectable part 110 to the second mechanically connectable part 140 in such a way as to ensure proper electrical or optical conduction between the two mechanically connectable parts. Moreover, the two mechanically connectable parts 110 and 140 may have any other shape or design as the one illustrated in FIGS. 1A-1B, as long as the mechanically connectable parts 110 and 140 are in close physical contact with each other. Such a close physical contact may be, for example, a connector system or a locking mechanism.

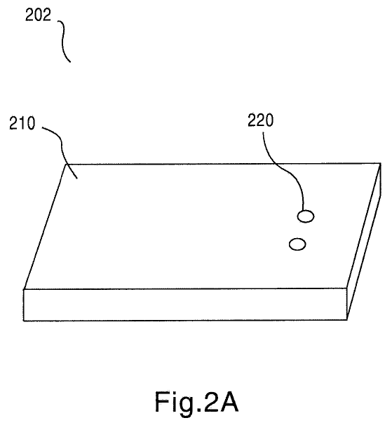

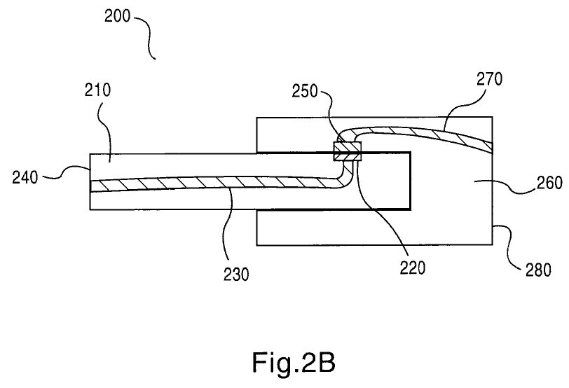

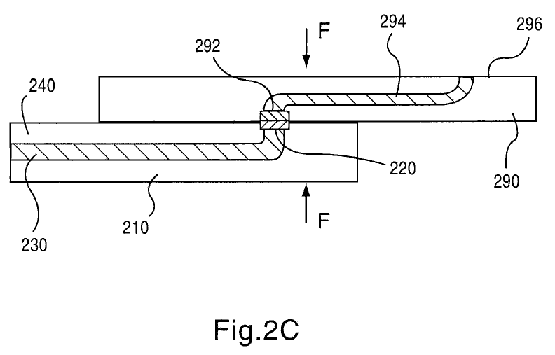

FIG. 2A is a perspective view of an exemplary connector system 202 that is also a male electrical/optical connector. In FIG. 2A, the connector system 202 comprises a mechanically connectable part such as a body portion 210, and one or more embedded pads 220. According to various exemplary aspects of this invention, the one or more embedded pads 220 may comprise copper, brass, gold, aluminum, or any other electrically or optically conductive material. Thus, the embedded pads 220 may ensure adequate electrical or optical conductivity between the mechanically connectable part 210 and another mechanically connectable part. For example, if the connector system 202 is part of an aircraft wing, the embedded pads 220 may be used to transmit current to structural circuits inside the mechanically connectable part 210. Transmission of electrical or optical current in the mechanically connectable part 210 may allow, via the intrinsic impedance of the structural circuits inside the mechanically connectable part 210, to generate heat in order, for example, to melt any ice buildup that may take place on the wing during cold weather or at high altitude. The embedded pads 220 may conduct electricity, for example, provided from a power source located remotely to the wing.

In operation, the embedded pads 220 may be placed in contact with other embedded pads, for example, if the mechanically connectable part or portion 210 is a male connector portion, and is coupled to, for example, a female mechanically connectable part such as a physical connector portion 260, as illustrated in FIG. 2B. If the mating female physical connector 260 includes one or more circuit paths 270 that are connected to embedded pads 250, and if the embedded pads 250 come into contact with the embedded pads 220 of the mechanically connectable parts 210, then an electrical or optical circuit may be completed.

FIG. 2B is a side view of the exemplary male physical connector 210 engaged in a mating relationship to a mechanically connectable parts such as a female physical connector 260. As shown in FIG. 2B, the mechanically connectable part such as a male physical connector portion 210 includes at least one embedded pad 220, and the female connector portion 260 includes at least one embedded pad 250. The embedded pad 250 may be connected to a circuit path 270 such as, for example, an electrical or optical circuit path. Also, the physical connector portions 210 and 260 may be coupled together in a mating relationship. According to various exemplary aspects, the embedded pad 220 may be electrically connected to an outside surface 240 of the mechanically connectable part 210 via a circuit path 230. Similarly, the embedded pad 250 may be connected to an outside surface 280 via the circuit path 270.

Accordingly, when the circuit path 230 is connected to a power source, electrical or optical current may be transmitted via the circuit path 230 to the embedded pad 220 and to the embedded pad 250. Thus, for example, when either one of the mechanically connectable parts 210 or 260 are connected to a power source, the electrical current generated by the power source may be transmitted from, for example, the male physical connector portion 210 to the female physical connector portion 260 via the circuit paths 230 and 270 and the embedded pads 220 and 250. According to various exemplary aspects of this invention, the circuit paths 230 and/or 270 may generate heat because of their intrinsic impedance when an electrical current is generated. Accordingly, actions such as de-icing the surface of a part that is physically and electrically/optically connected to either one of the connector portions 210 and 260 by the application of an electrical current is rendered possible.

FIG. 2C is a side view of another exemplary variation of a connector system including a connection between two mechanically connectable parts, the first mechanically connectable part 210 and a second mechanically connectable part 290. In FIG. 2C, the first mechanically connectable part 210, which includes embedded pads 220 that are electrically connected to an outer surface 240 via the circuit path 230, may be coupled to a second mechanically connectable part 290. Both mechanically connectable parts 210 and 290 may be clamped together, soldered, welded, nailed or otherwise joined together. The symbol “F” in FIG. 2C represents such a joining method that brings together both physical connectors 210 and 290. According to various exemplary aspects of this invention, the second mechanically connectable parts 290 may include one or more embedded pads 292 that may be electrically or optically connected to an outer surface 296 of the mechanically connectable part 290 via the circuit path 294. Also, the mechanically connectable part 290 may be placed in an operational relationship with the mechanically connectable part 210. According to various exemplary aspects of this invention, when the mechanically connectable part 210 and the mechanically connectable part 290 are functionally coupled, or joined together, as illustrated in FIG. 2C, the embedded pads 220 of the first mechanically connectable part 210 and the embedded pads 292 of the second mechanically connectable part 290 come in contact with each other in a way that ensures electrical conductivity between the embedded pads 220 and 292. Accordingly, an electrical circuit may be completed that includes the embedded pads 220 and 292. According to various exemplary aspects of this invention, a mechanical pressure, illustrated by the force F in FIG. 2C, may be applied to at least one of the first mechanically connectable part 210 and the second mechanically connectable part 290 to keep the embedded pads 220 and 292 in close enough contact with each other such that electrical or optical conductivity can be created and maintained between the two mechanically connectable parts 210 and 290. Alternatively, the embedded pads 220 and 292 may be kept in contact with each other via soldering, welding, plating, or any other joining method.

It should also be noted that although the circuit paths and pads referred to in the description below are referred in an exemplary manner as electrical conductors, they may similarly provide optical or other connecting functions.

Furthermore, while aspects of the present invention have been described in conjunction with the exemplary variations outlined above, alternatives, modifications and improvements, and/or substantial equivalents, whether known or that is or may be presently unforeseen, may become apparent to those having at least ordinary skill in the art. Accordingly, the exemplary aspects of the present invention, as set forth above, are intended to be illustrative, not limiting. Various changes may be made without departing from the spirit and scope thereof. Therefore, aspects of the present invention are intended to embrace all known or later-developed alternatives, modifications, variations, improvements, and/or substantial equivalents.

What is claimed is:

1. A connector system for use with a plurality of mechanically connectable parts, the system comprising:
a first one of the mechanically connectable parts having a first surface and a first embedded pad coupled to a first circuit path; wherein the first embedded pad adjoins the first surface, the first embedded pad being electrically or optically connectable; and
a second one of the mechanically connectable parts having a mechanical joining mechanism for attaching the second one and the first one of the mechanically connectable parts, the second one of the mechanically connectable parts having a second surface and a second embedded pad coupled to a second circuit path; wherein the second embedded pad adjoins the second surface, the embedded pad being electrically or optically connectable;
wherein each of the first embedded pad and the second embedded pad are exposed and situated so as to enable an electrical or optical connection of the first circuit path and the second circuit path via the first embedded pad and the second embedded pad.

2. The connector system of claim 1, wherein the mechanical joining mechanism comprises at least one selected from a group consisting of nailing, soldering, pinning, riveting welding, clamping, mating and gluing.

3. The connector system of claim 1, wherein at least one of the first embedded pad and the second embedded pad is electrically or optically conductive.

4. The connector system of claim 1, wherein each of the first embedded pad and the second embedded pad comprises at least one selected from a group consisting of copper, brass, gold and aluminum.

5. The connector system of claim 1, wherein at least one of an electrical circuit and an optical circuit is formed between the first circuit path and the second circuit path via the first embedded pad and the second embedded pad.

6. The connector of claim 5, wherein:
the first one of the mechanically connectable parts is a male portion;
the second one of the mechanically connectable parts is a female portion;
and the male portion and the female portion are joined to each other in a mating relationship.

7. The connector of claim 6, wherein the male portion and the female portion are joined together via at least one of a group consisting of nailing, soldering, pinning, welding, clamping, mating and gluing.

8. The connector of claim 1, wherein at least a portion of one the first circuit path and the second circuit path generates heat when connected to a power source.

9. The connector of claim 1, wherein the mechanically connectable parts comprise aircraft parts.

10. A method of manufacturing a connector system for use with a plurality of mechanically connectable parts, the method comprising:
assembling components of a composite material;
embedding one or more pads in the components of the composite material; such that at least one of the one or more pads is on a surface of the composite material; wherein
the at least one or more pads on the surface of the composite are exposed; and
wherein the at least one or more pads are each electrically or optically connected to a circuit path.

11. A method of coupling a connector system for use with a plurality of mechanically connectable parts comprising a first one of the mechanically connectable parts having a first surface and a first embedded pad coupled to a first circuit path; wherein the first embedded pad adjoins the first surface, the first embedded pad being electrically or optically connectable; and a second one of the mechanically connectable parts having a second surface and a second embedded pad coupled to a second circuit path; wherein the second embedded pad adjoins the second surface, the second embedded pad being electrically or optically connectable; the method comprising:
placing each of the exposed first embedded pad and the second embedded pad into close proximity so as to enable an electrical or optical connection of the first circuit path and the second circuit path via the first embedded pad and the second embedded pad; and
attaching the second one and the first one of the mechanically connectable parts.

12. The method of claim 11, wherein attaching the second one and the first one of the mechanically connectable parts comprises at least one selected from a group consisting of soldering, welding, plating, pinning, gluing, clamping and mating.

13. The method of claim 11, wherein the second one and the first one of the mechanically connectable parts form an electrical or optical circuit.

14. The method of claim 11, wherein each of the first embedded pad and the second embedded pad comprises at least one selected from a group consisting of copper, brass, gold and aluminum.

15. The method of claim 11, wherein:
the first one of the mechanically connectable parts is a male portion;
the second one of the mechanically connectable parts is a female portion; and
the male portion and the female portion are joined to each other in a mating relationship.

16. The method of claim 15, wherein the male portion and the female portion are joined together via at least one selected from a group consisting of nailing, soldering, pinning, welding, clamping, mating and gluing.

17. The method of claim 11, further comprising generating heat when at least a portion of one the first circuit path and the second circuit path is connected to a power source.

18. The method of claim 11, wherein the mechanically connectable parts comprise aircraft parts.

19. The method of claim 10, wherein at least one of the one or more pads comprises at least one selected from a group consisting of copper, brass, gold and aluminum.

20. The method of claim 10, further comprising generating heat when the first circuit path is connected to a power source.
